(19) United States
(12) Patent Application Publication
(10) Pub. No.: US 2013/0115017 A1
(43) Pub. Date: May 9, 2013

(54) CHIP BREAKER SYSTEM, COOLING CHANNEL, COOLING CHANNEL SYSTEM AND HIGH-SPEED REAMER COMPRISING AT LEAST ONE THEREOF

(71) Applicant: GUEHRING OHG, Albstadt (DE)

(72) Inventors: Gerhard SCHANZ, Burladingen (DE); Manfred BECK, Sigmaringen (DE)

(73) Assignee: GUEHRING OHG, Albstadt (DE)

(21) Appl. No.: 13/625,351

(22) Filed: Sep. 24, 2012

Related U.S. Application Data
(63) Continuation of application No. PCT/EP2011/054493, filed on Mar. 23, 2011.

(30) Foreign Application Priority Data
Mar. 25, 2010 (DE) 102010012959.3
May 5, 2010 (DE) 102010019598.7
May 7, 2010 (DE) 102010019840.4
May 26, 2010 (DE) 102010021520.1

(51) Int. Cl. B23D 77/00; B23C 5/16; B23B 51/06; B23C 5/28

(52) U.S. Cl. CPC B23D 77/006; B23D 77/00; B23C 5/28; B23C 5/165; B23B 51/06
USPC 407/11; 408/229; 407/115; 407/30; 408/59

(57) ABSTRACT

The description shows a chip breaker system for a drilling, turning, milling or reaming tool, wherein the chip breaker system comprises: a portion of a flute and a first area which is produced by a progressive cut, wherein a first edge is arranged between the portion and the first area in such a way that chips produced by a cutting movement of the drilling, turning, milling or reaming tool can be broken at the first edge. The application further relates to a high-speed reamer comprising such a chip breaker system, a reamer made of solid carbide, a reamer with axially extending cooling channels which are disposed in a decentralized manner, a reamer with cooling channels which are unevenly distributed in the peripheral direction, and a reamer with cooling channels, wherein the outlet openings of the cooling channels are arranged on different cutting planes.

### AREA OF THE INVENTION

The present invention relates to a chip breaker system for a drilling, turning, milling or reaming tool, a cooling channel for supplying the cutting edges of a drilling, turning, milling or reaming tool, and a high-speed reamer for remachining a borehole of a work piece.

### BACKGROUND OF THE INVENTION

Known in prior art are high-speed reamers, which can be used to finish boreholes through reaming, wherein this is intended in particular to improve the surface quality.

### SUMMARY OF THE INVENTION

While in use, reamers can generate chips, wherein the chips can swirl around, and thereby cause damage to the surface of the work piece to be machined, for example. In particular long chips can here pose a risk of damage. For this reason, an effort is essentially always made to ensure that only small chips can come about during the machining process, if at all possible.

Therefore, one object is to provide a reamer, in particular a high-speed reamer, which is characterized by the generation of the smallest possible chips while in use.

A first embodiment of the invention provides a chip breaker system for a drilling, turning, milling or reaming tool, wherein the chip breaker system encompasses: a portion of a flute and a first area generated by a progressive cut, wherein a first edge is arranged between the portion and the first area in such a way that chips generated by a cutting movement of the drilling, turning, milling or reaming tool can be broken at the first edge.

Generating an edge between an area formed by a progressive cut and a flute makes it possible to produce a chip breaker, wherein the edge can assume the function of a “chip breaker”.

A second embodiment of the invention provides a cooling channel for supplying a flute of a drilling, turning, milling or reaming tool, wherein the cooling channel is essentially arranged along the longitudinal axis of the drilling, turning, milling or reaming tool, wherein the cooling channel is decentralized in design.

A third embodiment of the invention provides a cooling channel system for supplying the cutting edges of a drilling, turning, milling or reaming tool, wherein the cooling channel system encompasses at least two cooling channels, wherein a respective two cooling channels generate angles with the midpoint, wherein the angles measure 20°, 30°, 40°, 50°, 60°, 70°, 80°, 90° or any angular value desired.

The arrangement of cooling channels unevenly or unsymmetrically distributed in a circle makes it possible to address an uneven or unsymmetrical arrangement of primary cutting edges and accompanying flutes, while still ensuring that the cooling channels can empty directly into respective flutes (without arranging additional channel sections).

A fourth embodiment of the invention provides a high-speed reamer for finishing a borehole of a work piece, wherein the high-speed reamer encompasses: A cooling channel according to one of claim 5 or 6 and/or a cooling channel system according to one of claim 7 or 8.

A fifth embodiment of the invention provides a high-speed reamer for finishing a work piece, wherein the high-speed reamer consists of solid carbide.

A tool made out of solid carbide exhibits a longer service life, since carbide is a very hard, and hence resistant, material. The high-speed reamer according to the invention advantageously exhibits not just partial elements, e.g., cutting edges, consisting of carbide, but rather is made out of carbide overall, so that a high-speed reamer according to the invention can be manufactured more easily on the one hand, and a solid carbide high-speed reamer exhibits a longer service life on the other.

Exemplary embodiments will be described in the dependent claims.

Provided according to an exemplary embodiment of the invention is a chip breaker system wherein the chip breaker system encompasses a second area, wherein the second area can be generated by the or an additional progressive cut, wherein a second edge is arranged between the second area and the flute in such a way that chips generated by a cutting movement of the drilling, turning, milling or reaming tool can be broken at the second edge.

A progressive cut can yield several, e.g., two, areas that can exhibit edges bordering a flute. These edges can outwardly protrude to such an extent that arising chips can break at the edges.

Another embodiment of the invention according to the invention provides a chip breaker system, wherein the first area is arranged roughly perpendicular to the second area.

Provided according to another exemplary embodiment of the present invention is a chip breaker system, wherein the first edge is arranged so as to run roughly axially, and/or wherein the second edge is arranged so as to run roughly radially.

Another embodiment according to the invention provides a cooling channel, wherein the cooling channel is arranged in such a way that the cooling channel empties into the flute after the flute has been fabricated.

Known in prior art, for example, are reamers that exhibit a cooling channel, wherein the cooling channel is arranged so as to run axially, and wherein the cooling channel has a centralized design, i.e., the longitudinal axis of the cooling channel coincides with the longitudinal axis of the reamer. Therefore, in order to supply flutes with coolant and/or lubricant, a connection must be established between the corresponding flute and centralized cooling channel. This connection is usually established through electro-erosion machining. However, electro-erosion machining causes the material properties to change in the region adjacent to the connecting portion, specifically weakening in particular this adjacent region in terms of its mechanical stability. Further, the quasi-two-part structural design of the cooling channel requires that the coolant and/or lubricant be diverted, since a straight flow is no longer possible. A division, here by approx. 90°, leads to a segregation of the air/oil mixture while lubricating the cutting edges of the cutting tool via minimum quantity lubrication, which is why minimum quantity lubrication is not possible given a reamer from prior art as described here.

By contrast, a cooling channel according to the invention traces a straight line toward the flute to be supplied, and requires no other boreholes or openings to supply the cutting edges, making it possible to avoid additional working steps or a weakened mechanical stability of the reamer resulting from the additional working steps.

Another exemplary embodiment of the present invention provides a cooling channel system, wherein the angular values on the drilling, turning, milling or reaming tool alternate.

According to the invention, the cooling channels can be arranged as desired, even unsymmetrically, in a circle, whose midpoint coincides with the longitudinal axis of the drilling, turning, milling or reaming tool, which allows differing angular values to arise between the individual cooling channels. An alternative arrangement might involve alternating angular values, for example the angular values between the cooling channels could measure 50°, 60°, 70°, 50°, 60°, 60° or exhibit any other angular value sequences desired, which can alternate or be completely unsymmetrical.

Another exemplary embodiment of the present invention provides a high-speed reamer, wherein the high-speed reamer encompasses a main cutting edge and flute, wherein the high-speed reamer encompasses a chip breaker system according to one of claims 1 to 4.

Another exemplary embodiment of the present invention provides a high-speed reamer, wherein the high-speed reamer is high-toothed and/or wherein the high-speed reamer exhibits cooling channels with outlet openings, wherein the outlet openings are situated on a sectional plane or on various sectional planes, wherein the sectional planes can be perpendicular to the longitudinal axis of the high-speed reamer and/or wherein at least one cooling channel is aligned radially or inclined in a radial direction.

One idea of the present invention can be regarded as generating a chip breaker via a progressive cut, wherein the progressive cut can yield an area potentially leading to an edge as the result of a chip produced by a cutting movement. This edge can here (in terms of its shape and elevation) be designed as a chip breaker, and takes the form of a boundary between the area and flute. According to the invention, the edge should further be as extensive as possible, i.e., project far out of the area or flute, so as to be able to perform the function of a chip breaker.

Of course, the individual features can also be combined with each other, which may in part also result in advantageous effects going beyond the sum of individual effects.

### BRIEF DESCRIPTION OF THE DRAWINGS

Additional details and advantages to the invention are made evident based on the exemplary embodiments depicted in the drawings. Shown on:

FIG. 1 is a perspective view of a high-speed reamer;

FIG. 2 is a perspective view of another high-speed reamer;

FIG. 3 is a schematic view of another high-speed reamer;

FIG. 4 is a schematic view of another high-speed reamer;

FIG. 5 is a schematic view of another high-speed reamer;

FIG. 6 is a perspective view of another high-speed reamer;

FIG. 7 is a front view of another high-speed reamer;

FIG. 8 is a perspective view of another high-speed reamer;

FIG. 9 is a rear view of another high-speed reamer;

FIG. 10 is a perspective view of another high-speed reamer;

FIG. 11 is a perspective view of another high-speed reamer;

FIG. 12 is another high-speed reamer according to the invention;

FIG. 13 is another high-speed reamer according to the invention;

FIG. 14 is another high-speed reamer according to the invention;

FIG. 15 is another high-speed reamer according to the invention;

### DETAILED DESCRIPTION OF EXEMPLARY EMBODIMENTS

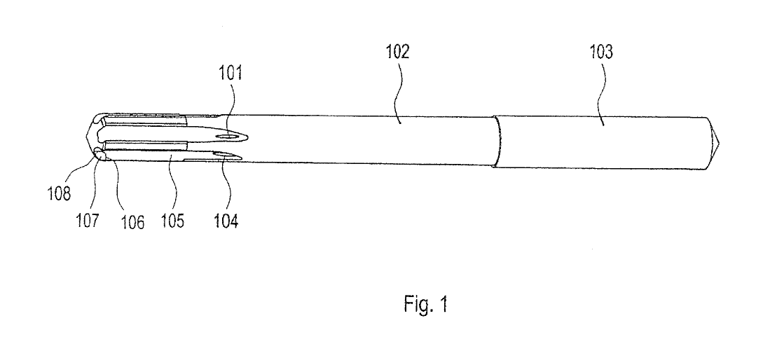

FIG. 1 shows a high-speed reamer according to the invention with a portion 103 of the shank for clamping and a remaining shank, which can be referred to as the neck 102. The high-speed reamer exhibits straight flutes 105, into which coolant channels 101, 104 for conveying coolant and/or lubricant can empty. Progressive cuts can be performed on the high-speed reamers, which can lead to one or more areas 107 on the high-speed reamer. According to the invention, the progressive cuts are made in such a way that an edge 106, 108 can be formed between an area 107 and the flute 105. The edge 106, 108 can exhibit a roughly axially running portion 108 and a roughly radially running portion 106. The edge 106, 108 acts as a disruptive edge for chips, wherein the chips can be broken owing to the edge 106, 108. Depending on application, e.g., machining tool steels, brass or aluminum, the edge 106, 108 can here be made more or less extensive in design, so as to be able to break arising chips.

High-speed reamers according to prior art exhibit a central cooling channel, wherein this cooling channel can be “tapped” with radially running channel portions, so that the flutes can be supplied with coolant and/or lubricant. The radially running channel portions are here fabricated in particular via electro-erosion machining, wherein the material properties of the edge regions around these channel portions can change. In particular, the change in material properties can result in a weakening of the affected regions, making these regions more prone to fractures. In addition, these cooling channels of prior art with at least two channel portions require that the coolant and/or lubricant stream be diverted, since the coolant and/or lubricant streaming toward the flute must first flow along an axially running channel portion, followed by a radially running channel portion. During minimum quantity lubrication (MQL), this diversion of the coolant and/or lubricant stream can cause a separation of the air/oil mixture, so that an effective lubrication can no longer be ensured. By contrast, the high-speed reamer according to the invention can exhibit a cooling channel 101, 104, which is not situated so as to run centrally. The cooling channel 101, 104 is here arranged in such a way that, while manufacturing a flute 105, e.g., through grinding, an outlet opening in the cooling channel 104 can automatically come about for supplying the flute 105 with coolant and/or lubricant. This eliminates the need for the subsequent arrangement of radially running channel portions, as required in the high-speed reamers of prior art. For this reason, the high-speed reamers according to the invention make it possible to avoid a weakening of material caused by electro-erosion machining. In addition, the cutting edges of the high-speed reamer can be supplied via the cooling channels 101, 104 through minimum quantity lubrication, since a separation of the air/oil mixture can be prevented by the straight flow of the coolant and/or lubricant stream. It is alternatively possible to provide a high-speed reamer that can make 2, 3, 4 or a plurality of cooling channels available for each flute, wherein the high-speed reamer can also exhibit flutes that have no cooling channel allocated to them.

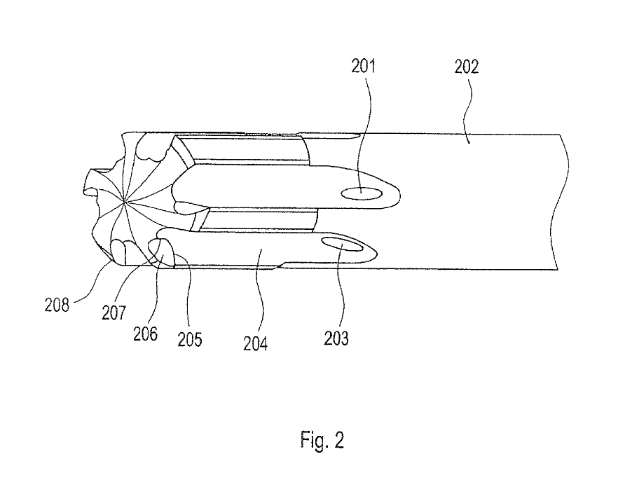

FIG. 2 shows a high-speed reamer with a neck 202 and cooling channels 201, 203 for coolant and/or lubricant, which can empty into flutes 204. For example, the high-speed reamer can exhibit six primary cutting edges 208. In an alternative embodiment, the high-speed reamer according to the invention can also exhibit 2, 3, 4, 5, 7, 8, 9, 10, 11, 12 or however many primary cutting edges desired. One or more areas 206 are generated on the high-speed reamer by one or more progressive cuts. The area 206 can be delineated from the flute 204 by an edge 205, 207. The edge 205, 207 can be divided into two portions 205, 207, wherein a roughly axially running portion 207 can pass over into a roughly radially running portion 205. The area 206 comprises part of a chip breaker system, wherein chips produced by a primary cutting edge 208 can be routed through the area 206 and guided to the edge 205, 207, at which the chips can finally be broken up.

According to the invention, the high-speed reamer exhibits axially running, decentralized cooling channels, wherein the cooling channel can allow the coolant and/or lubricant to flow to the flute along a straight line. As a result, the air/oil mixture obtained from minimum quantity lubrication can be prevented from separating. In addition, subsequent electro-erosion machining for manufacturing connecting channels between a centrally arranged cooling channel and the flutes can be avoided in the high-speed reamers according to the invention.

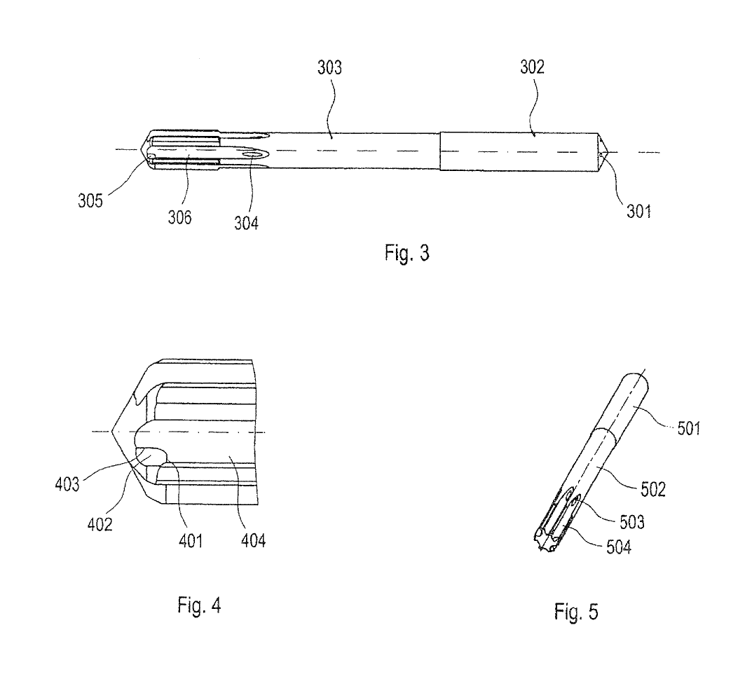

FIG. 3 shows a high-speed reamer with a shank portion 302 for clamping purposes and a neck 303. The high-speed reamer further exhibits cooling channels with inlet openings 301 and outlet openings 304. The outlet openings 304 guide the coolant and/or lubricant to flutes 306. At least one progressive cut was performed at the high-speed reamer, which can yield at least one area 305 designed in such a way according to the invention that the area 305 can be used as part of a chip breaker system.

FIG. 4 shows the high-speed reamer on FIG. 3 with the flute 404 and area 402 generated by a progressive cut. The flute 404 and area 402 are separated from each other by the edge 401, 403, wherein, according to the invention, the edge 401, 403 represents a part of the chip breaker system, and can ensure that at most only small chips can arise with a high-speed reamer in operation.

FIG. 5 shows a high-speed reamer with shank portions 501, 502, outlet openings 503 of cooling channels and flutes 504.

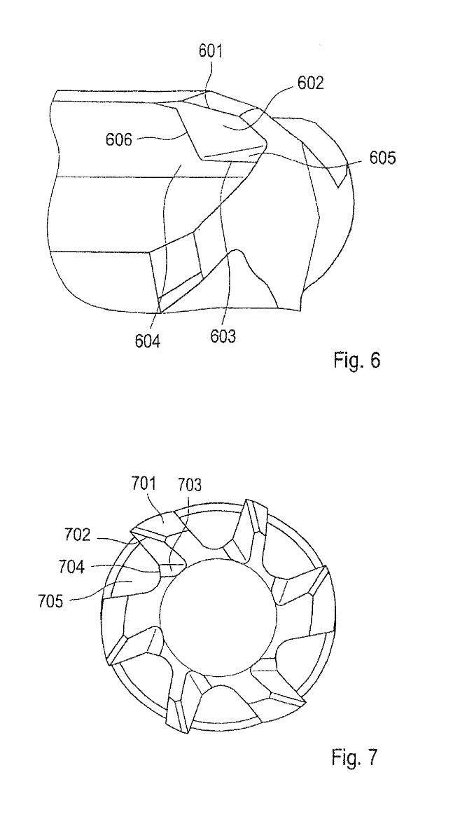

FIG. 6 shows a high-speed reamer according to the invention with a primary cutting edge 601, wherein at least one progressive cut can produce areas 602, 605, which in conjunction with a flute 604 can yield edges 603, 606. The chips generated by the primary cutting edge 601 can be broken by the edges 603, 606, so that predominantly only small chips can come about.

FIG. 7 shows a front view of a high-speed reamer, wherein the reamer can exhibit six primary cutting edges 702, which can be adjoined by respective open spaces 701. The flute 705 borders an area 703 generated by at least one progressive cut, wherein the boundary between the flute 705 and area 703 can yield an edge 704, which can take the form of a disruptive edge. Chips produced by the primary cutting edge 702 can also be conveyed through the area 703, specifically in such a way that the chips can be guided on the edge 704. The edge 704 can be designed in such a way that, i.e., be elevated to a height where, the chips can be bent or broken by the edge 704, for example. Therefore, the combination of area 703, edge 704 and flute 705 can be configured as a chip breaker system or chip breaker.

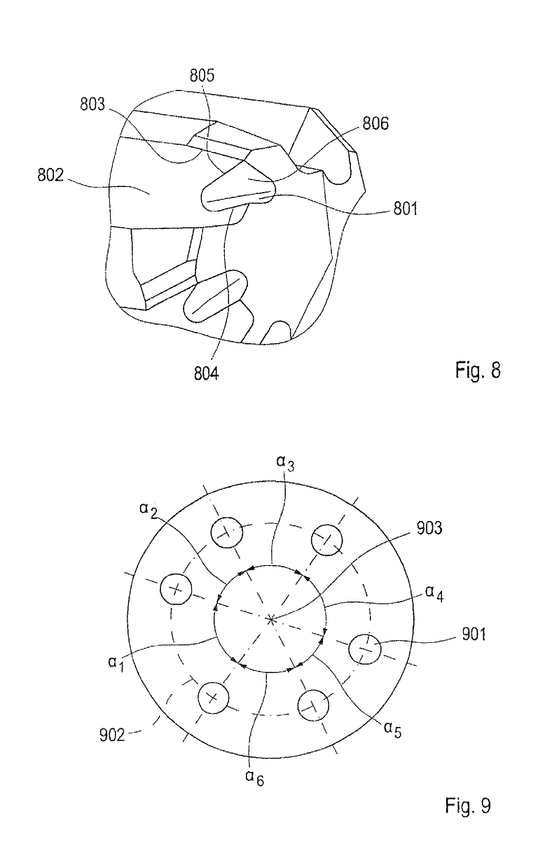

FIG. 8 shows a high-speed reamer with primary cutting edges 803, which exhibit flutes 802, and surfaces 801 that can be generated by a progressive cut. In addition, an edge 804 can be formed between the area 801 and flute 802.

FIG. 9 shows a rear view of a high-speed reamer, wherein six cooling channels 901 are depicted, which can be designed to run axially, but are not centrally arranged according to the invention. The cooling channels 901 can here be situated in such a way as to provide a cooling channel 901 for each flute that empties into the flute, wherein a straight flow of the coolant and/or lubricant is ensured, thereby making it possible to prevent the separation of an air/oil mixture during minimum quantity lubrication.

FIG. 9 presents an exemplary embodiment of a high-speed reamer, wherein a respective two cooling channels 901 can generate an angle with the midpoint 903. The angles α₁, α₂, α₃, α₄, α₅, α₆ can here be generated, wherein angles α₁ and α₄ can have a value of approx. 70°, angles α₂ and α₅ a value of approx. 50°, and angles α₃ and α₆ a value of approx. 60°. In an alternative embodiment, an equal division with identical angular values can also be performed. Further alternative embodiments can provide any desired number of cooling channels corresponding to the number of flutes, which can be situated to reflect a uniform division or any type of division desired. For example, angles of 20°, 30°, 40°, 50°, 60°, 70° or 80° can here be established between the individual cooling channels, wherein angles with identical or different angular values can be formed between the individual cooling channels.

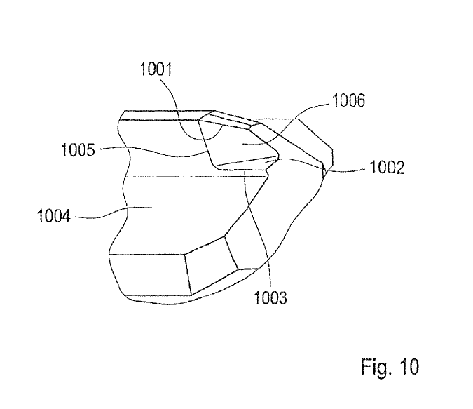

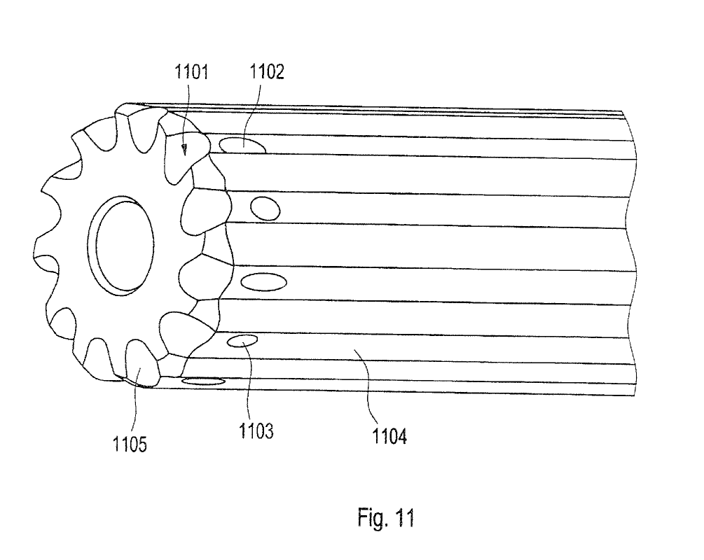

FIG. 10 shows a high-speed reamer with a primary cutting edge 1001, wherein a progressive cut is able to produce areas 1002, 1006 that can lead to edges 1003, 1005 between the areas 1002, 1006 and flute. The areas 1002, 1006 can guide chips produced by the primary cutting edge 1001 to the edges 1003, 1005, where the latter can be broken by the edges 1003, 1005.

FIG. 11 shows another high-speed reamer according to the invention in an exemplary embodiment with twelve cutting edges 1101. The high-speed reamer can be designed as a multi-toothed, in particular high-toothed, cutting tool, and here exhibit twelve or more then twelve cutting edges, e.g., 13, 14, 15, 16, 17, 18, 19, 20 or more cutting edges. The high-speed reamer can also exhibit less than twelve cutting edges. Outlet openings of cooling channels 1102, 1103 can be located in proximity to several or all cutting edges 1101. The outlet openings 1102, 1103 of all or several outlet openings can lie on a sectional plane aligned perpendicular to the longitudinal axis of the high-speed reamer. In an alternative embodiment, each outlet opening can lie on a respectively different sectional plane, wherein the sectional planes are arranged perpendicular to the longitudinal axis of the high-speed reamer. The cooling channels can be radially aligned. In an alternative embodiment, the cooling channels can exhibit a longitudinal axis that is not aligned perpendicular to the longitudinal axis of the high-speed reamer. In this case, the cooling channels are not radially aligned, but rather bent in a radial direction. The outlet openings 1102 in this instance do not exhibit any circular outlet openings as for radially aligned cooling channels; instead, the edges of the outlet openings are elliptical in design. In an alternative embodiment, the high-speed reamer according to the invention can exhibit in part circular outlet openings 1103 of cooling channels and/or in part elliptical outlet openings 1102 of cooling channels. Individual or all outlet openings of cooling channels can lie in a flute 1105 in an alternative embodiment of a high-speed reamer. In another alternative embodiment, individual or all outlet openings can be situated in a respective heel 1104. The high-speed reamer according to the invention can exhibit one or more decentralized cooling channels, whose outlet openings are produced while grinding out one or more heels 1104. In this case, at least one cooling channel empties into a heel. In another alternative embodiment of a high-speed reamer, at least one or precisely one cooling channel empties into each heel. As an alternative, the high-speed reamer exhibits several outlet openings of cooling channels, wherein the cooling channels each empty into the heel, i.e., the respective outlet openings are each situated in a respective heel, wherein the outlet openings lie in various sectional planes, wherein the sectional planes are aligned perpendicular to the longitudinal axis of the high-speed reamer. Therefore, grinding out a heel can yield an outlet opening of a cooling channel aligned in a decentralized manner, which is why the length or radial depth of the grinding process can cause the outlet opening to be arranged in an axial direction. In another alternative embodiment of a high-speed reamer, individual or all outlet openings of cooling channels can be situated between a respective flute and an adjacent heel. In another alternative embodiment, the high-speed reamer is made completely out of carbide metal. Therefore, this case would involve a solid carbide high-speed reamer.

According to the invention, the provided chip breaker system with an area that can be produced by a progressive cut and an edge between this area and the flute can also be arranged on normal reamers, wherein the edge can be suitable for breaking arising chips. In addition, the chip breaker system according to the invention can also be used on spiral reamers.

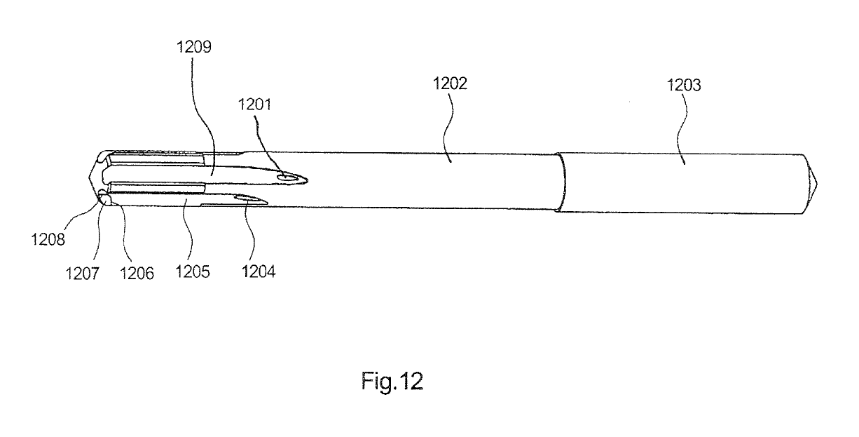

FIG. 12 shows a high-speed reamer with outlet openings 1201, 1204 for decentralized coolant channels, wherein the outlet openings 1201, 1204 can be produced through grinding or while fabricating the flutes. According to the invention, flutes 1209 can be ground further in the direction of the clamping shank 1203, or flutes 1205 can be ground not as far in the direction of the clamping shank 1203. Obtained in the first case are outlet openings 1201 located further away from the primary cutting edge, so that coolant and/or lubricant can be oriented toward the cutting edges/tool cutters/primary cutting edges in a more widely distributed or more broadly fanned out manner. Not grinding the flutes 1205 as far in the direction of the clamping shank 1203 makes it possible to produce outlet openings 1204 that are situated closer to the tool cutting edges, and thus able to more specifically and precisely direct coolant and/or lubricant toward the tool cutting edges.

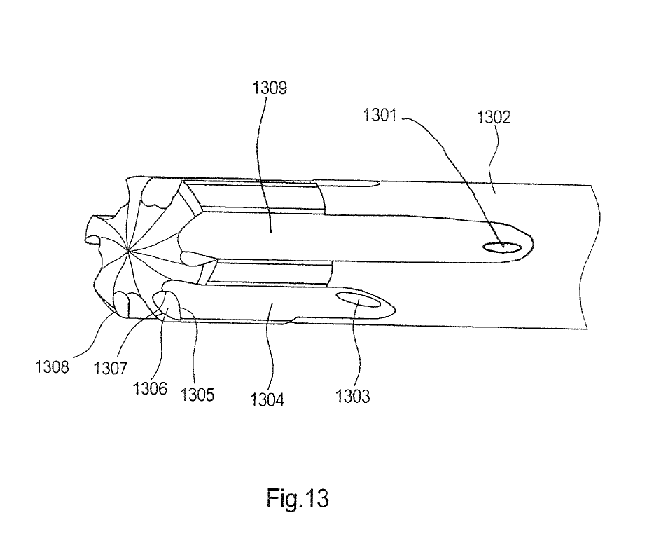

FIG. 13 shows a high-speed reamer with a flute 1309, which is ground far in the direction of the neck 1302 of the tool, which can yield an outlet opening 1301 located far away from the tool cutting edges/primary cutting edges 1308. This can result in a coolant and/or lubricant stream on the tool cutting edges 1308 that is more widely distributed. The invention can provide tools whose flutes are ground into the shank to varying degrees. Alternative embodiments provide tools whose flutes are ground in the direction of the tool shank to roughly the same distance.

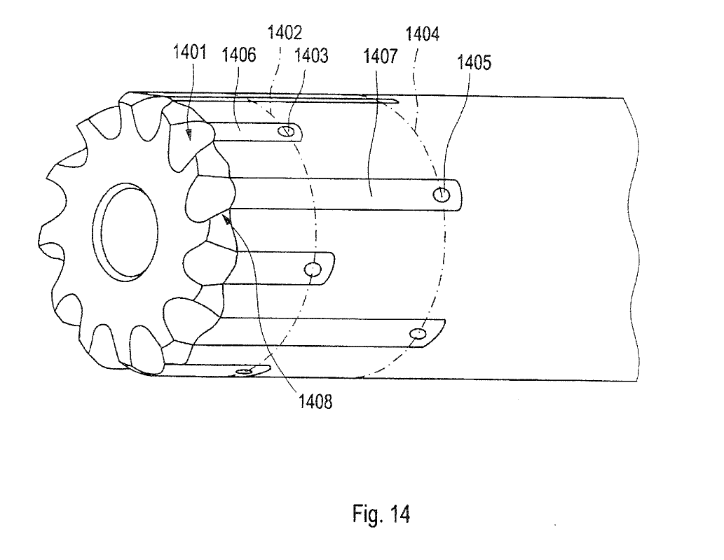

FIG. 14 shows a high-speed reamer with tool cutting edges 1401, 1408, wherein flutes 1406, 1407 have been ground into the tool to varying degrees, which can yield outlet openings 1403, 1405 located at different distances from the tool cutting edges 1401, 1408. The outlet openings 1403, 1405 can be arranged in varying cross sectional planes 1402, 1404. The cross sectional planes 1402, 1404 can be aligned perpendicular to a longitudinal axis of the tool. If the outlet openings 1403 are situated closer to the tool cutting edges 1401, the tool cutting edges 1401 can be supplied more precisely with coolant and/or lubricant. If the outlet openings 1405 are located farther away from the tool cutting edges 1408, the coolant and/or lubricant jet supplied to the tool cutting edges 1408 can be fanned out more broadly.

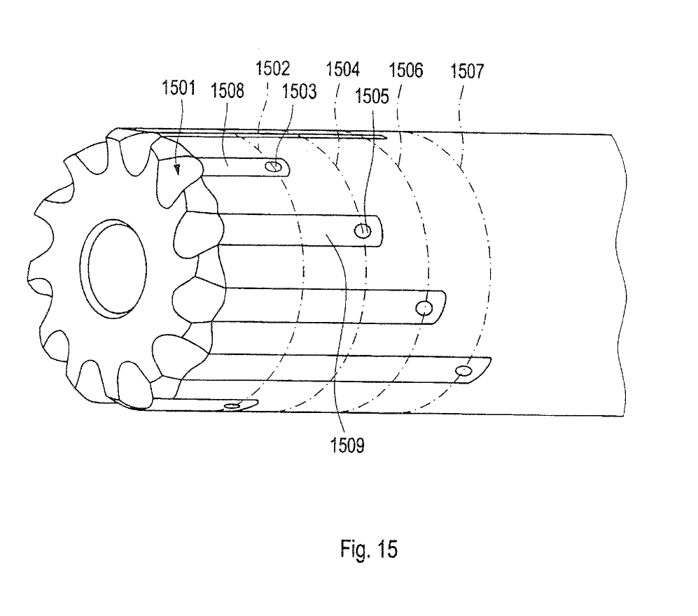

FIG. 15 shows a tool with decentralized coolant channels, wherein flutes 1508, 1509 are ground into the tool in the direction of the shank in a staggered manner or to varying degrees. This can result in outlet openings 1503, 1505 that can be arranged on different cross sectional planes 1502, 1504, 1506, 1507.

Let it be noted that the term “encompass” does not preclude other elements or procedural steps, just as the term “a” and “an” do not rule out several elements.

The used reference numbers serve only to enhance understandability, and must in no way be regarded as limiting, wherein the protective scope of the invention is reflected by the claims.

### LIST OF REFERENCE NUMBERS

101 Cooling channel
102 Neck
103 Clamping section
104 Cooling channel
105 Flute
106 Edge
107 Area
108 Edge
201 Outlet opening, cooling channel
202 Neck
203 Outlet opening, cooling channel
204 Flute
205 Edge
206 Area
207 Edge
208 Primary cutting edge
301 Inlet opening, cooling channel
302 Clamping portion
303 Neck
304 Outlet opening, cooling channel
305 Area
306 Flute
401 Edge
402 Area
403 Edge
404 Flute
501 Clamping portion
502 Neck
503 Outlet opening, cooling channel
504 Flute
601 Primary cutting edge
602 Area
603 Edge
604 Flute
605 Area
606 Edge
701 Open space
702 Primary cutting edge
703 Area
704 Edge
705 Flute
801 Area
802 Flute
803 Primary cutting edge
804 Edge
805 Edge
806 Area
901 Cooling channel
902 Circle
903 Midpoint
1001 Primary cutting edge
1002 Area
1003 Edge
1004 Flute
1005 Edge
1006 Area
1101 Cutting edge
1102 Outlet opening, cooling channel
1103 Outlet opening, cooling channel
1104 Heel
1105 Flute
1201 Outlet opening, cooling channel
1202 Neck
1203 Clamping portion
1204 Outlet opening, cooling channel
1205 Flute
1206 Edge
1207 Area
1208 Edge
1209 Flute
1301 Outlet opening, cooling channel
1302 Neck
1303 Outlet opening, cooling channel
1304 Flute
1305 Edge
1306 Area
1307 Edge
1308 Primary cutting edge
1309 Flute
1401 Tool cutting edge
1402 Cross sectional plane
1403 Outlet opening, coolant channel
1404 Cross sectional plane
1405 Outlet opening, coolant channel
1406 Flute
1407 Flute
1408 Tool cutting edge
1409 Tool cutting edge
1502 Cross sectional plane
1503 Outlet opening, coolant channel
1504 Cross sectional plane
1505 Outlet opening, coolant channel
1506 Cross sectional plane
1507 Cross sectional plane
1508 Flute
1509 Flute

1. A chip breaker system for a drilling, turning, milling or reaming tool, the chip breaker system comprising:
a first portion of a flute, and
a first area generated by a progressive cut, wherein a first edge is arranged between the portion and the first area in such a way that chips generated by a cutting movement of the drilling, turning, milling or reaming tool can be broken at the first edge.

2. The chip breaker system according to claim 1, wherein the chip breaker system comprises a second area, wherein the second area can be generated by the or an additional progressive cut, wherein a second edge is arranged between the second area and the flute in such a way that chips generated by a cutting movement of the drilling, turning, milling or reaming tool can be broken at the second edge.

3. The chip breaker system according to claim 2, wherein the first area is arranged roughly perpendicular to the second area.

4. The chip breaker system according to claim 2, wherein the first edge is arranged so as to run roughly axially, and/or wherein the second edge is arranged so as to run roughly radially.

5. A cooling channel for supplying a flute of a drilling, turning, milling or reaming tool, the cooling channel is essentially arranged along the longitudinal axis of the drilling, turning, milling or reaming tool, wherein the cooling channel is decentralized in design.

6. The cooling channel according to claim 5, wherein the cooling channel is arranged in such a way that the cooling channel empties into the flute after the flute has been fabricated.

7. A cooling channel system for supplying cutting edges of a drilling, turning, milling or reaming tool, wherein the cooling channel system comprises at least two cooling channels, wherein a respective two cooling channels generate angles with the midpoint, wherein the angles measure 20°, 30°, 40°, 50°, 60°, 70°, 80°, 90° or exhibit any angular value desired, and/or wherein the angular values on the drilling, turning, milling or reaming tool alternate.

8. A high-speed reamer for remachining a borehole of a work piece, wherein the high-speed reamer comprises:
a cooling channel arranged along a longitudinal axis of the reamer, the cooling channel decentralized in design, and/or
a cooling channel system that comprises at least two cooling channels, a respective two cooling channels generate angles with the midpoint, the angles measure 20°, 30°, 40°, 50°, 60°, 70°,80°, 90° or exhibit any angular value desired, and/or
wherein the high-speed reamer encompasses comprises:
a primary cutting blade and
a flute, and the high-speed reamer comprises a chip breaker system that comprises a first portion of a flute and a first area generated by a progressive cut, a first edge arranged between the portion and the first area in such a way that chips generated by a cutting movement of the reamer can be broken at the first edge.

9. A high-speed reamer for finishing a work piece, wherein the high-speed reamer is made out of solid carbide.

10. The high-speed reamer according to claim 9, wherein the high-speed reamer is high-toothed and/or wherein the high-speed reamer exhibits cooling channels with outlet openings, wherein the outlet openings are situated on a sectional plane or on various sectional planes, wherein the sectional planes can be perpendicular to the longitudinal axis of the high-speed reamer and/or wherein at least one cooling channel is aligned radially or inclined in a radial direction.
